(19) United States
(12) Patent Application Publication
(10) Pub. No.: US 2011/0093546 A1
(43) Pub. Date: Apr. 21, 2011

(54) METHOD AND SYSTEM FOR SORTING ELECTRONIC COMMUNICATIONS

(76) Inventor: Bryan Rubingh, Lansing, MI (US)

(21) Appl. No.: 12/904,654

(22) Filed: Oct. 14, 2010

Related U.S. Application Data
(60) Provisional application No. 61/251,800, filed on Oct. 15, 2009.

(51) Int. Cl. G06F 15/16

(52) U.S. Cl. 709/206

(57) ABSTRACT

A method of sorting a message from a sender to a recipient based on a key code incorporated in, attached to, or logically associated with the message, and ascertaining the validity of the key code.

### CROSS-REFERENCE TO RELATED APPLICATION

This application claims the benefit of U.S. Provisional Patent Application No. 61/251,800, filed Oct. 15, 2009, which is incorporated herein by reference in its entirety.

### BACKGROUND OF THE INVENTION

The invention relates to sorting and verification of electronic messages.

FIG. 1 is a flow diagram demonstrating a method of sorting messages as known in the prior art 10. A message is received over a communications network from the sender to the recipient at 12. The received message is then analyzed by filters which attempt to determine if the message is one that the recipient wishes to receive at 14. If the filter determines that the message is desired by the recipient, then the message is moved to the recipient's inbox at 18. On the other hand, if the filters do not allow passage, then the message is moved to a trash or junk folder at 16. The filter in this prior art method 40 can be incorporated within an email viewing software such as Microsoft Outlook® or Mozilla Thunderbird® or a web-based viewer such as Yahoo! Mail® or Google Gmail®. The sorting may be based upon prior emails that have been designated as junk email by the user, by scanning the subject line, by scanning through the main body of the email, or by scanning any attachments on the email. Such sorting methods are not robust enough to accurately allow wanted emails and prevent unwanted emails, since the filters do not have any way of knowing with a high level of certainty what string of text in the subject line or the body of the email may be indicative of an unwanted message. Often spam mail may be sent from multiple email addresses so that the filters may not learn the source of spam and use that as a sorting criterion. The generators of spam may also use forged identifiers and addresses to circumvent address and identity based filtering. Furthermore, merely encountering an unknown attachment may not be an indication of an unwanted message.

### SUMMARY OF THE INVENTION

In one aspect, the invention relates to a method of sorting a message received from a communications network. The method ascertains whether a key code is associated with the message by using messaging software in a controller. If no key code is associated with the message, then the message is assigned to a first category. If a key code is associated with the message, then the method checks whether the key code is valid by comparing it to a database in a memory, and if validated, then assigning the message to a second category. If the key code is invalid, then it is assigned to the first category.

A further aspect of the invention relates to a system for sorting a message received from a communications network with an electronic device having a controller, access to a memory, messaging software, and a connection to a communications network. The memory has a database of valid key codes. When the electronic device is connected to a communications network and a message is received from the communications network, the controller can ascertain whether a key code is associated with the message using the communication software, and checking whether a key code is valid by comparing it to the database of valid key codes.

A method of preparing a message for sending over a communications network by identifying a recipient for the message, and ascertaining whether a key code has been provided by the recipient by searching a database. If a key code has not been provided, then a new key code is obtained from the recipient. The sender then associates either the existing key code or the new key code to the message for transmission over the communications network.

### BRIEF DESCRIPTION OF THE DRAWINGS

In the drawings:

FIG. 1 is a flow diagram demonstrating a method of filtering messages as known in the prior art.

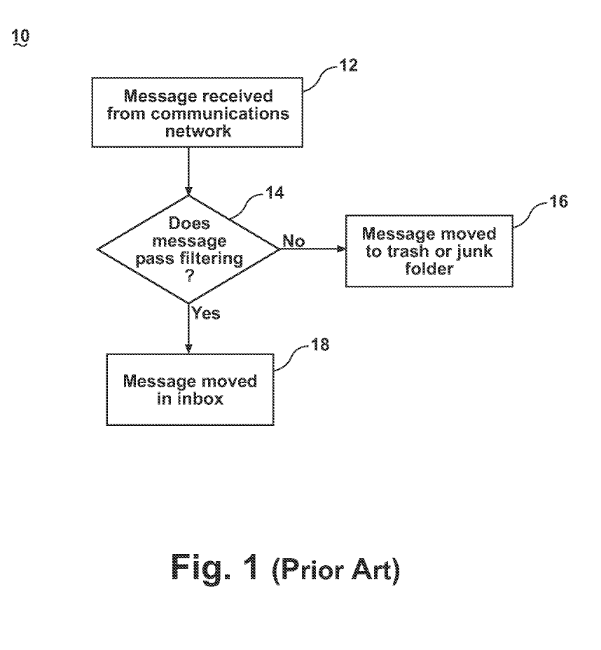

FIG. 2 is a schematic diagram of a communications system with N nodes capable of communication with other nodes on a communication network. Each node can be operated according to an embodiment of the current invention.

FIG. 3 is a schematic representation of an electronic device that can communicate on the communications system of FIG. 2 according to one embodiment of the current invention.

FIG. 4 is a flow diagram demonstrating a method of sorting messages with an associated key code according to an embodiment of the current invention.

FIG. 5 is a schematic diagram of the message such as might be used in FIG. 3 comprising a key code and multiple communications packets.

FIG. 6 is a flow diagram demonstrating a method of sorting messages by a sender identifier and an associated key code according to another embodiment of the current invention.

FIG. 7 is a schematic representation of a messaging software interface showing various levels of trust according to the method of sorting messages as depicted in FIG. 6.

FIG. 8 is a flow diagram demonstrating a method of sending messages according to an embodiment of the current invention.

FIG. 9 is a flow diagram demonstrating a method of receiving a message and assigning a private key code to a sender according to one embodiment of the current invention.

FIG. 10 is a flow diagram demonstrating a method to change a key code.

FIG. 11 is a flow diagram demonstrating a method to request and forward a verified referral according to one embodiment of the current invention.

FIG. 12 is a flow diagram demonstrating a sorting of messages in a telephone network or Voice over Internet Protocol (VoIP) according to one embodiment of the current invention.

FIG. 13 is a flow diagram demonstrating a sorting of messages as applied to Instant Messaging (IM) according to one embodiment of the current invention.

### DESCRIPTION OF AN EMBODIMENT OF THE INVENTION

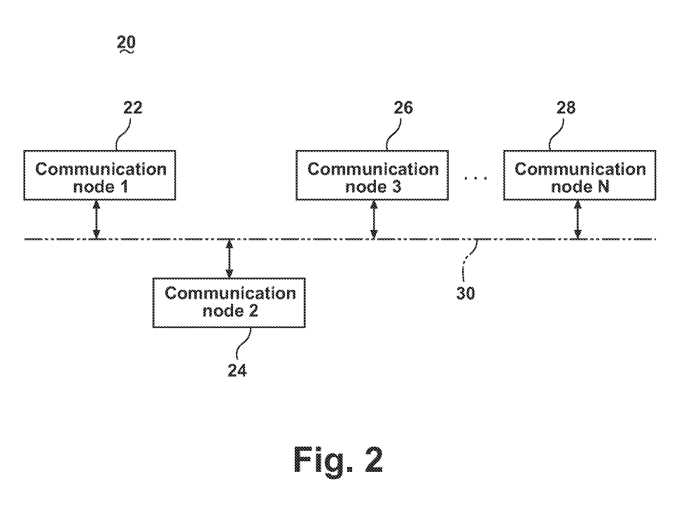

FIG. 2 is a schematic diagram of a messaging system 20 with N communications nodes 22, 24, 26, and 28 each capable of communication with other nodes 22, 24, 26, and 28 on the messaging system 20 via a communications network 30. This messaging system 20 can be operated according to the messaging methods disclosed herein.

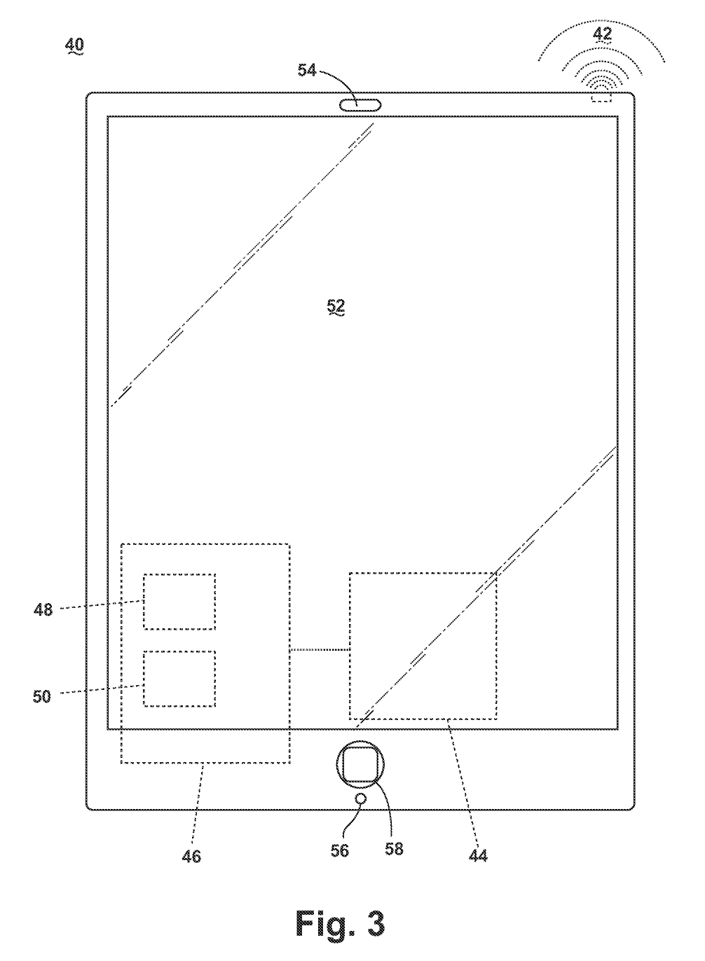

The communication nodes 22, 24, 26, and 28 may be electronic devices 40 that are capable of two way communications on a communication network 30. An exemplary electronic device 40 is shown in FIG. 3. The device 40 can have a controller 44 that controls the functions of the electronic device including interfacing with the user of the electronic device 40, as well as, constructing, sending and receiving messages over the communications network 30 via a communications link 42. Examples of electronic devices 40 include, but are not limited to, servers, desktop computers, laptop computers, pad computing devices, smart televisions, smart phones, smart appliances, cellular telephones, and satellite telephones. Examples of controllers 44 incorporated with the electronic devices 40 may include, but are not limited to, a microprocessor, microcontroller, field programmable gate array (FPGA), digital signal processor (DSP), application specific integrated circuit (ASIC), or combinations thereof. One or more of the electronic devices 40 can also contain electronic memory 46 such as any variety of volatile or non-volatile memory, such as dynamic random access memory (DRAM), static random access memory (SRAM) or electrically erasable programmable read only memory (EEPROM). The electronic devices 40 can also have messaging software 50 stored in the electronic memory 46 and capable of being run on the controller. The electronic memory 46 can also be used to store any number of databases, including a database 48 containing information about other nodes, as well as information about recipients at other nodes that the electronic device 40 can communicate with via the communications network 30. The electronic device 40 can have a variety of interfaces between a user and the device, such as a monitor, display screen, speaker 54, vibration generator, microphone 56, touch screen 52, keyboard, mouse and/or an input switch 58.

The communications network 30 can be any type of network for transmitting and receiving messages, including but not limited to the internet, a telephone system, local area networks (LAN), wide area networks (WAN), or intranets. Each of the nodes 22, 24, 26, and 28 and the associated electronic devices 40 may be connected to the communications network 30 temporarily or permanently by a variety of communications links 42 including but not limited to wired links, such as Ethernet, coaxial, twisted pair or optical fiber, or any variety of wireless links and protocols including, but not limited to Wireless Fidelity (WiFi)®, Bluetooth®, Worldwide Interoperability for Microwave Access (WiMax)®, and Long Term Evolution (LTE)®. Such links may be provided by one or more vendors, including but not limited to cable companies, satellite based television companies, landline phone and digital subscriber line (DSL) companies, and mobile phone companies. Each node 22, 24, 26, and 28 may further have a unique address that allows the respective node 22, 24, 26, and 28 to be uniquely identified amongst the other nodes on the communications network 30. For example, if the communications network 30 is the internet, then the unique address for each of the nodes 22, 24, 26, and 28 may be an internet protocol (IP) address. On the other hand if the communications network 30 is a telephone network, then the unique address of each of the nodes 22, 24, 26, and 28 may be a unique phone number.

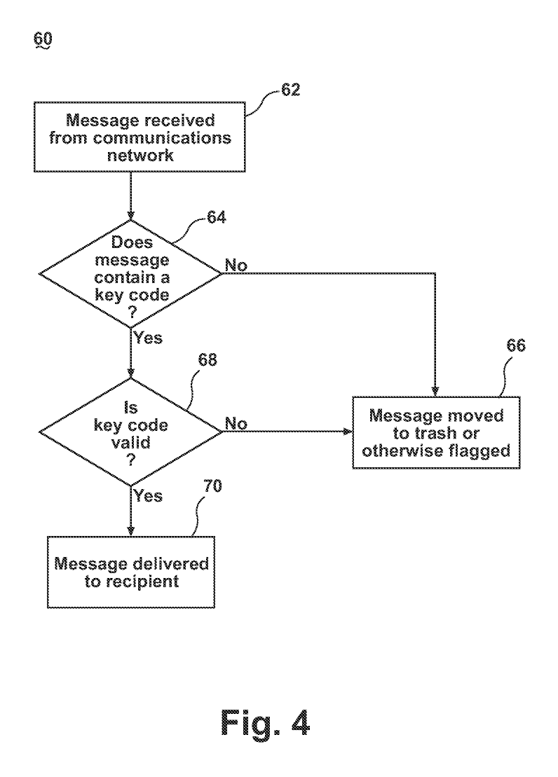

FIG. 4 is a flow diagram demonstrating a method 60 of sorting messages with a key code according to one embodiment of the current invention. A message is received from the communications network 30 at 62. The message is checked to see if there is an associated key code at 64. A key code is data provided by a recipient to a sender of one or more messages, which can be used by the recipient, in accord with the invention, to sort messages received from the sender. The key code is provided to the sender by a recipient, and can be associated with the message by the sender, but a key code is not necessary in order to convey the substantive information of the message. In other words, a message can be sent with or without a key code. But if sent without a key code, the recipient cannot sort the message according to the invention. The key code can be associated with a message in a variety of ways, such as by incorporating it into the message, attaching it to the message, or logically associating it with the message. If the message lacks an associated key code then the message is moved to a trash or junk folder on the messaging software 50 at 66. If there is a key code, then the key code is checked to see if it is a valid key code at 68. If it is not a valid key code, then the message is moved to a trash folder or otherwise flagged at 66. If however, the key code is valid, then the message is delivered to the recipient at 70. In this aspect, sorting of messages involves assigning each message to a category, such as various categories of confidence or trust.

The method 60 of FIG. 4 can be implemented within an email messaging software such as Microsoft Outlook® or Mozilla Thunderbird® running on a user's electronic device 40 or a web-based viewer such as Yahoo! Mail® or Google Gmail® running on a remote or cloud server. When the message is received at 62, it may be received by either the recipient's electronic device 40 or a remote server. At 64, the messaging software 50 running on the recipient's electronic device 40 may scan or parse the message to find the associated key code.

The messaging software 50 running on the recipient's electronic device 40 or a mail viewing interface on a remote mail interface can move messages to different folders. One such folder can be an inbox that is designated for wanted messages and another folder can be a junk folder designated for holding unwanted messages. The messages that are in the inbox may also contain a marker for the level of trust associated with each message. At step 66, the message can be automatically deleted, or may be stored in a junk folder for the recipient to check before deleting. At step 70, a trusted message, with a valid key code, can be delivered to the recipient to view or hear.

Although, the embodiment of the invention of FIG. 4 is explained in the context of email, such a message sorting method 60 can be implemented in any messaging system 20 exchanging messages. For example the method 60 can be implemented on a telephone system where the key code might consist of some combination of the 12 keys commonly found on telephones. In such a case, the method 60 can eliminate unwanted telephone calls such as telemarketing calls. It could also be used in text messaging or short messaging service (SMS) systems where the method 60 can prevent unsolicited messages.

It is seen in FIG. 4 that the sorting method 60 does not need to make a judgment of the desirability of the message to the recipient based on the substantive content of the message itself. Instead, the method simply looks for a key code that, when valid, allows the message to be received by the recipient and, when non-existent or not valid, deletes or flags the message. Therefore, on the recipient's end, the method simply has to compare a key code to known valid key codes. Known valid key codes may be stored in the electronic memory of the recipient's electronic device 40.

In one implementation of the method 60, all messages sent over the communications network 30 require a key code. The key code required by a recipient to allow passage of the message to the recipient may be communicated to other nodes by publishing it where anyone can access it, by distributing the key code on a business card, by a potential recipient verbally communicating it to a potential sender, or by sending a key code message. This key code is then associated with the message so that the recipient can verify that the message is desirable. A key code may be assigned by the recipient to be valid for one or more message senders, such as a group of senders. A key code may also be established by a recipient as valid for a limited amount of time or for a limited number of uses. For example, a key code may expire and have to be updated every month or have to be updated when it has been used to send a finite number of messages, e.g., 100. Additionally, a recipient can change an assigned key code at any time and may choose to do so if the recipient believes that undesirable sources of messages have the obtained a current key code.

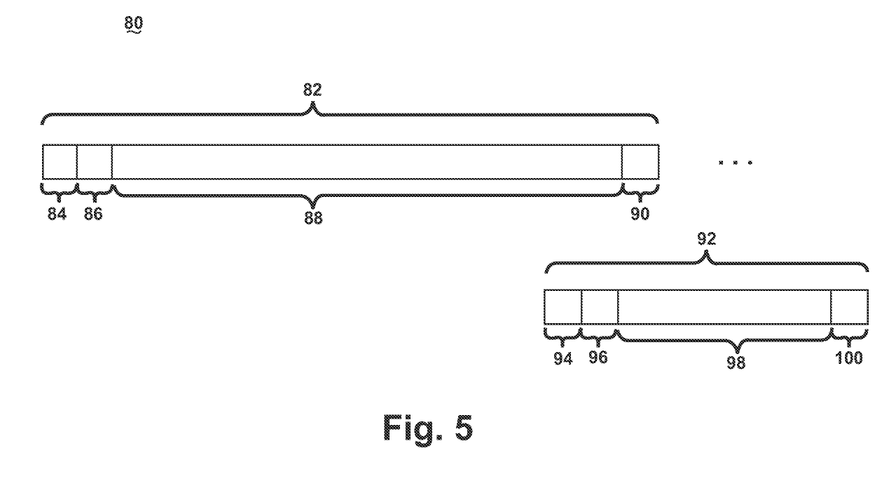

FIG. 5 is a schematic diagram of the message 80 of FIG. 4 comprising a key code 86 and multiple communications packets 82 and 92. Message 80 can be fragmented into multiple packets 82 and 92 for optimal transmission over a communications network 30. Each packet can have a header 84, 94 that may be one or more bytes and may include information about which node and address the respective packet 82, 92 is intended for. Each communications packet 82, 92 can also have a respective payload 88, 98, containing the message that is being transmitted. The communications packets 82, 92 can further have error checking bits 90, 100, such as a parity check or cyclic redundancy check. Communications packet 92 sent after the initial communication packet 82 may contain one or more bytes 96 that indicate the continuation from the previous communication packet and the need to concatenate the payload of the current packet with the payload of the previous packet to form the complete message. As shown here, the key code 86 may be near the beginning of the first communications packet 82 of the message 80. Alternatively, the key code could be embedded in any one of the communications packets 82, 92 that comprise the message 80 and at any location within the packets 82, 92. Additionally, the key code may be found in multiple communications packets 82, 92 of the message 80. As a further alternative, there may be multiple key codes, including a combination of public and private key codes in one or more of the packets that comprise the message, or the key code may be transmitted in a different packet or different logically associated message.

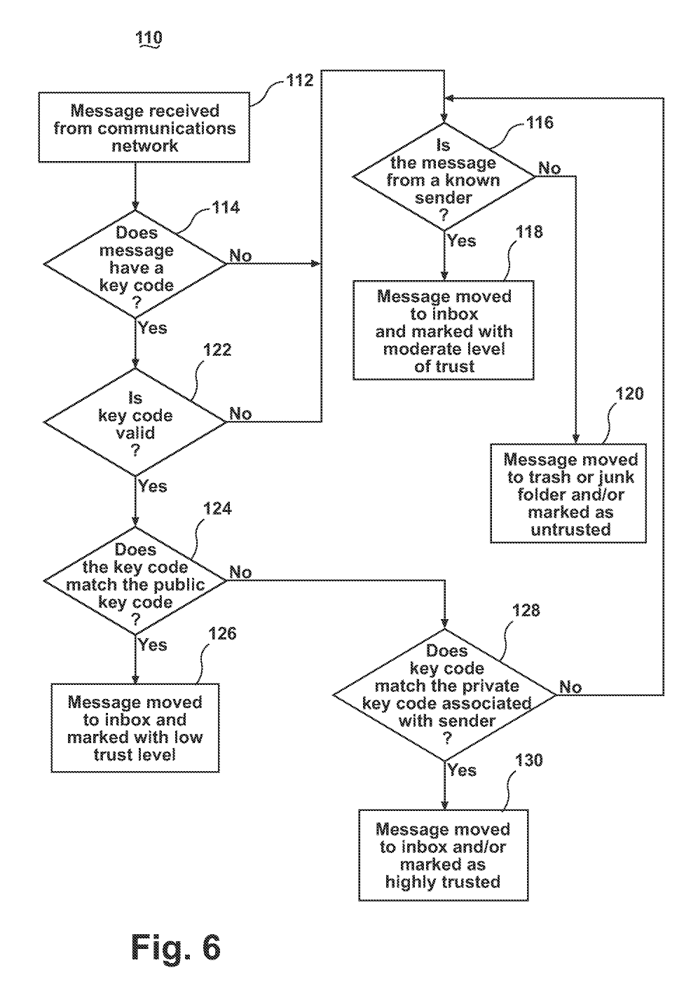

FIG. 6 is a flow diagram demonstrating a method of receiving and sorting messages 110 using a sender identifier and a key code associated with the message and assigning four levels of trust. When a message is received from the communications network 30 at 112, the messaging software 50 running on the electronic device 40 looks for a key code associated with the message at 114. If there is no key code at 114, then it is determined if the message is from a known sender at 116 such as by recognizing a sender identifier. A sender identifier is information associated with a sender by which a recipient can identify the sender, such as an image, a signature, a digital certificate, and the like. If the message is from a known sender, then the message is moved to the inbox and marked with a moderate level of trust at 118. If however, the message is not from a known sender, then the message is moved to a trash or junk folder and marked as not trusted at 120. A risk, of course, with relying solely upon a sender identifier is that a sender identifier can be forged. If a key code was found at step 114, then it is determined if the key code is valid at step 122. If the key code is not valid at 122, then it is ascertained if the message is from a known sender at 116 and then either moved to the junk folder at 120 or moved to the inbox and assigned a moderate level of trust at 118. If the key code is found to be valid at step 122, then it is next determined if the key code matches a public key code at 124. If the key code matches the public key code, then the message is moved to the inbox and marked with a low level of trust at 126. If however, at 124 the key code does not match the public key code, then it is determined if the key code matches a private key code related to the sender at 128. If it does, then the message is move to the inbox and marked as highly trusted at 130. Valid private key codes, assigned by recipients, provide a higher level of trust that the sender is bona fide. At 128, if it is determined that the key code neither matches a public key code nor a private key code, then the method loops to 116 where the message ends up in the junk folder at 120 if it is not from a known sender, or in the inbox and marked with a moderate level of trust if it is from a known sender at 118.

The method 110 of sorting messages based on the sender's identity and the key code associated with the message identifies the messages as being trash or having a first, second, or third level of confidence or trust. The first, second, and third level of confidence messages are moved into the inbox of the messaging software 50 and associated user interface and each of the messages are marked with its corresponding level of confidence or trust. It should also be noted that the sorting mechanism 110 described herein can also be used in conjunction with other methods of sorting a message, such as by running the message through an anti-virus software, and rejecting the message based on the possibility of it containing a virus, Trojan horse, spyware, or other malware. A public key code is a key code that is common and valid for more than one sender. A private key code is a key code that is specific and unique to a particular sender.

As in the case of the previous embodiment of message sorting 60 of FIG. 4, this method 110 can also be implemented within an email messaging software 50 such as Microsoft Outlook® or Mozilla Thunderbird® running on a user's electronic device 40 or a web-based viewer such as Yahoo! Mail® or Google Gmail® running on a remote or cloud server. When the message is received at 112, it may be received by either the recipient's electronic device 40 or on a remote mail server. At 114, the messaging software 50 running on the recipient's electronic device 40 may scan or parse the message to find the key code in the message. Alternatively, the scanning or parsing may be done at a remote mail server. Known valid key codes may be stored in a database in the electronic memory of the recipient's electronic device 40 or on a remote mail server and used at 122, 124, and 128 to ascertain if the key code is valid, matches a public key code, or matches a private key code of the sender, respectively. Additionally the recipient's address book and contacts 48 can be stored in the electronic memory 46 of the recipient's electronic device 40 or on a remote mail server and can be used to ascertain if the sender is known by the recipient at 116.

As in the case of sorting method 60 of FIG. 4, this embodiment also does not need to make a judgment of the desirability of the message to the recipient based on the contents of the message. Instead, the method 110 ascertains the desirability of the message based on the key code associated with the message and/or based on whether the recipient knows the purported sender of the message by some sender identifier.

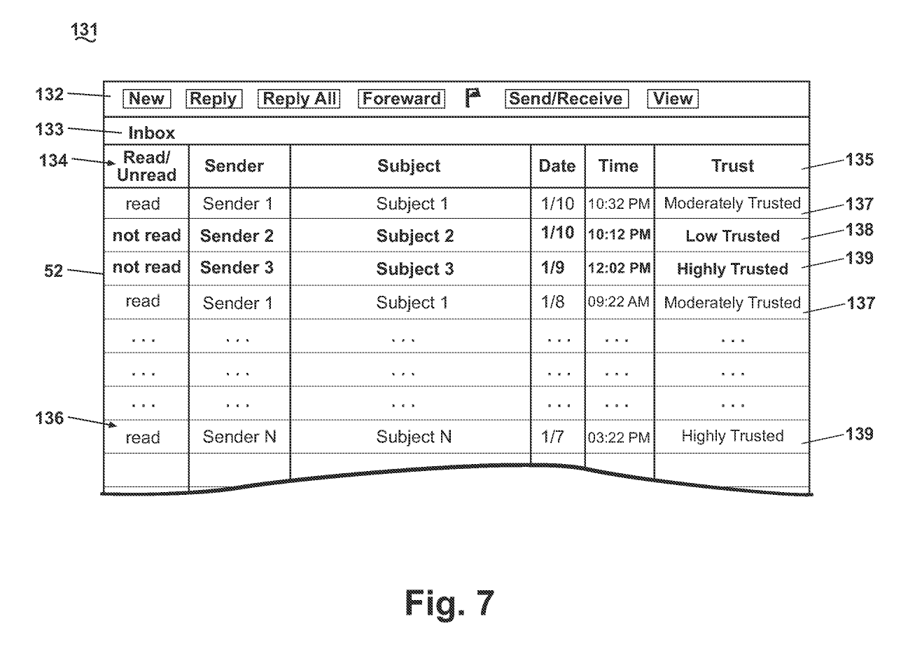

As mentioned above the messaging software 50 running on the recipient's electronic device 40 or a mail viewing interface on a remote mail interface can move messages to various folders, such as an inbox that is intended to contain messages that the recipient would consider wanted. A schematic representation of messaging software interface 131 displayed on the display screen 52 of the electronic device 40 is shown as FIG. 7. This inbox folder 133 can contain a menu of user functions 132, a header with multiple columns 134, and a main section 136 showing a listing of the messages along with various information of the message, such as whether the message is read or unread, the sender, the subject, date, time and the level of trust 135. In the embodiment 110 of FIG. 6, the least trusted messages are moved to the trash or junk folder at 120. There are three levels of trust above the least trusted messages that are designated as low level of trust 138, moderately trusted 137, and highly trusted 139, corresponding to a first, second, and third level of trust and moved into the inbox, at 126, 118, and 130, respectively. The various levels of confidence or trust within the inbox may be designated by color coding each level.

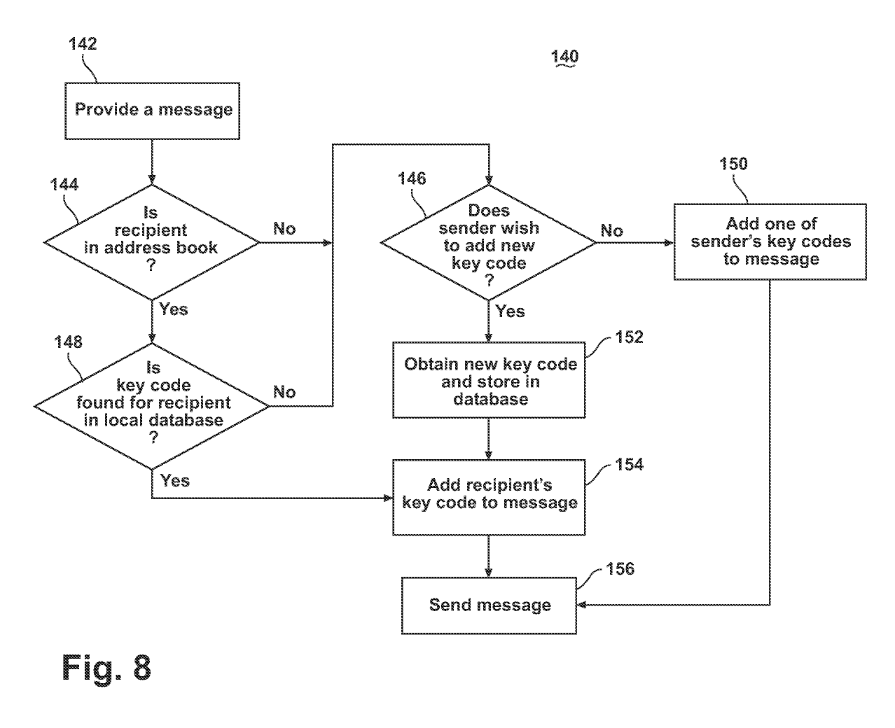

FIG. 8 is a flow diagram demonstrating a method of sending messages 140 with a key code. A message is provided by such means as copying it or composing it at 142, and is addressed by the sender to one or more recipients at 144, such as by locating the recipients in an address book. Before the message is sent on the communications network 30, however, the messaging software 50 running on the electronic device 40 or the remote mail server ascertains if each of the one or more addressed recipients has provided a key code to the sender, by checking at 148, for example, a database stored in the electronic memory of the sender's electronic device 40 or on a remote server. If a recipient has not provided to the sender a key code, as may be found in the address book or other database, then the messaging software 50 asks the sender if the sender wishes to add a new key code at 146. If the sender wants to add a new key code, then the sender obtains a new key code from the recipient at 152, and preferably stores it in the database. Obtaining a new key code may entail the sender requesting a new key code of the recipient by message or by other contact, joining a group where a public key has been distributed, or otherwise obtaining a key from one authorized to provide it to the sender. Once obtained, the sender can manually enter the key code into the electronic device 40 using an input device such as a keyboard. After entering the new key code and updating the database at 152, the key code provided to the sender by the designated recipient is added to the recipient's message at 154, and then the message is sent at 156. If back at 146, the sender did not wish to enter a new key code, then existing key codes will be added to the message at 150 and sent at 156. If at step 144 it is found that the recipient is in the address book, then it is determined if there is a key code from the recipient is in the address book at 148. This key code may either be a public or private key code. The key code provided to the sender by the recipient is next added to the message at 154 and the message is sent at 156.

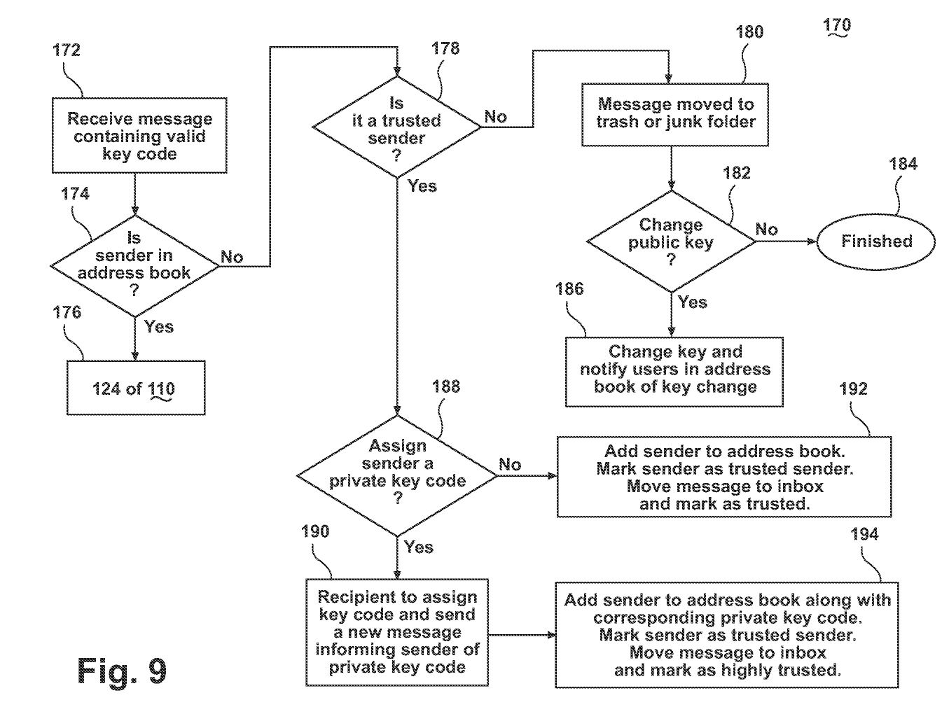

FIG. 9 is a flow diagram demonstrating a method of receiving a message from an unknown sender and assigning the sender a private key code 170. A message is received by a recipient with an associated public key code at 172. A determination is made whether the sender is in the recipient's address book at 174, and if the sender is in the address book, then the method proceeds with step 124 of the method 110 in FIG. 6. If the sender is not in the address book at 174, then the recipient is queried to determine if the sender is trusted at 178. If the sender is not trusted, then the message is moved to the trash or junk folder at 180 and the recipient is asked if the recipient wants to change the recipient's public key at 182. If so, then the key code is changed and the users in the address book are notified of the change in the key code at 186. Otherwise the method terminates at 184. At 178, if the sender is deemed to be trusted, then the recipient is queried to determine if the sender should be assigned a private key code at 188. If so, then the recipient assigns a private key code and sends a message informing the sender of the new private key code at 190. The sender is added to the address book along with the corresponding private key code, the sender is designated to be trusted, and the message is moved to the inbox and designated as highly trusted at 194. If at 188 the recipient did not choose to assign the sender a private key code, then the sender is added to the address book, the sender is designated as a trusted sender, and message is moved to the inbox and marked as trusted at 192.

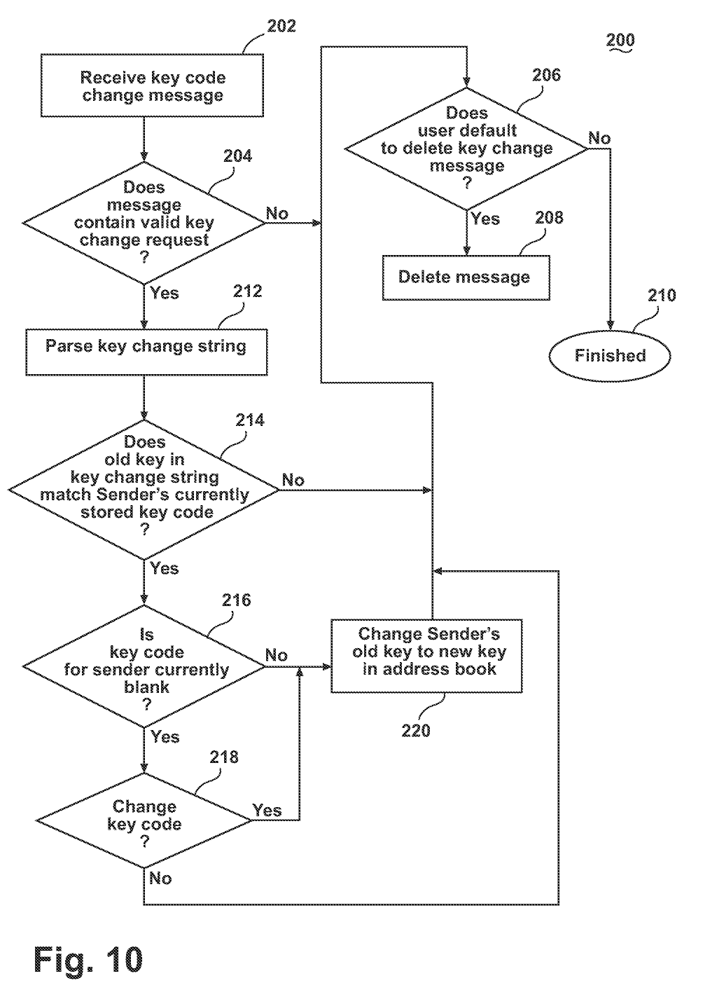

FIG. 10 is a flow diagram demonstrating a method to change a key code 200. A recipient receives a key change message at 202 and ascertains if the message contains a valid key change request at 204. This can be ascertained by parsing and checking the syntax of the message and determining if the syntax complies with the syntax required to initiate a change in the key code. If the message lacks a valid key change request, then it is determined if the user default is set to delete the key change messages at 206 and if it is set as such, then the message is deleted at 208 and otherwise the method terminates at 210. If however at 204 it is determined that the message contains a valid key code change request, then the change request string of the message is parsed at 212 to determine if the old key in the key change string matches the sender's currently stored key code at 214. If it does not match, then the method 200 proceeds to 206 where the method 200 is terminated either at 208 with or at 210 without deleting the key code change message. Next, it is determined if the key code for the sender is currently blank at 216. If it is blank, then the recipient is queried to determine if the recipient wants to change the key code at 218. If the recipient does not want to change the key code then the method 200 proceeds to 206 where it is terminated either at 208 with or at 210 without deleting the key code change message. If, however, the recipient wants to change the key code, then the address book is updated by changing the sender's key code from the old key code to the new key code at 220 and proceeds to 206 where the method 200 is terminated either at 208 with or at 210 without deleting the key code change message.

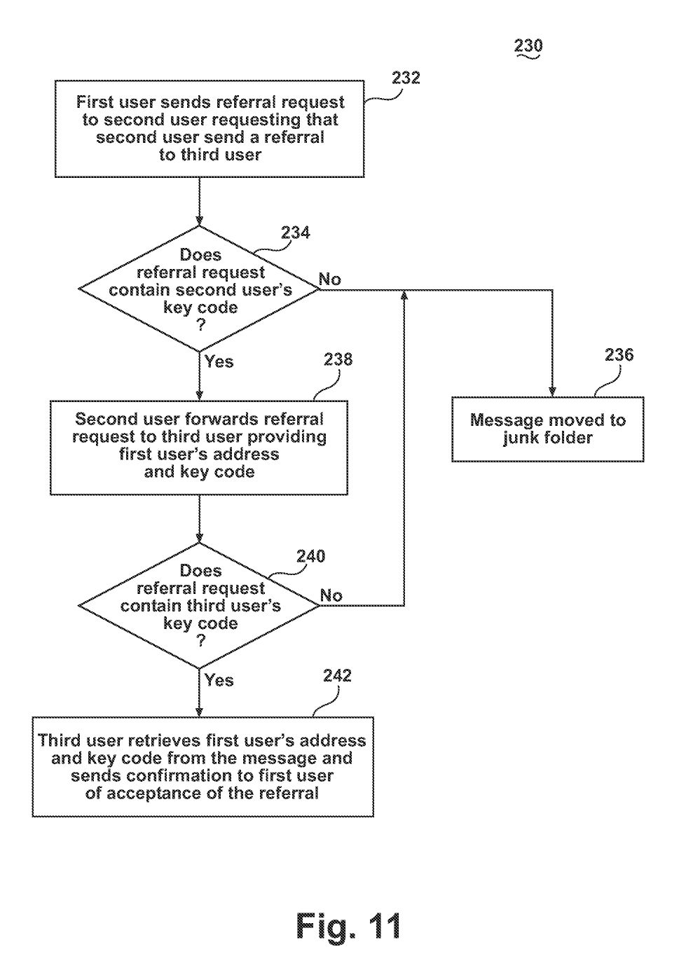

FIG. 11 is a flow diagram demonstrating a method 230 to request and send a referral between two users using a commonly known user. At 232, a first user sends a referral request to a second user, requesting that the second user send a referral to a third user on behalf of the first user. The second user then determines if the referral request message from the first user has the second user's key code associated with the referral request message at 234. If the second user's key code is not associated with the referral message, then the message is moved to the second user's junk folder at 236. If the second user's key code is associated with the referral message at 234, then the second user forwards the referral request to the third user, including the first user's address and key code at 238. Next, the third user determines if the referral request has the third user's key code associated with it at 240. If it does not, then the message is moved to the junk folder at 236. If the message has the third user's key code associated with it at 240, then the third user retrieves the first user's address and key code from the message and sends confirmation to the first user of acceptance of the referral at 242.

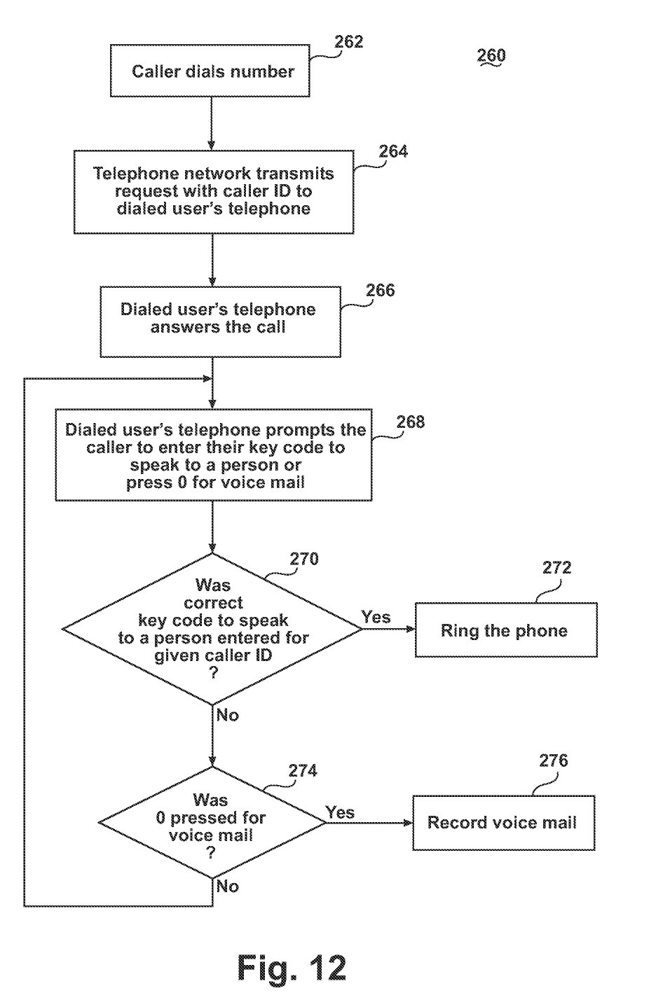

FIG. 12 is a flow diagram demonstrating a method 260 of sorting of messages applied to calls on a telephone network or to a Voice over Internet Protocol (VoIP). The caller dials a number at 262 and the network transmits the request for a call with caller identification information to the receiver's telephone at 264. The dialed receiver's telephone answers the call at 266 and prompts the caller to enter his or her key code to have the call routed through to the receiver or to press “0” to get the voice mail at 268. At 270, it is determined if the correct key code was entered for the given caller identification. If the correct key code was entered, then the phone is rung to prompt the receiver to pick up and talk to the caller at 272. If, however, the correct key code was not entered at 268, then it is determined if “0” was entered to access voicemail. If so, then the caller is allowed to record a voicemail at 276. Otherwise the method 260 loops back to prompting the caller to enter a key code at 268 to try to connect to the receiver again.

It should be noted that in the method 260 associated with the telephone network, the key code may be entered manually by the caller or the process can be automated. For example, the directory on the caller's phone may contain a receiver's name and phone number as known in the art, but it can also store a key code associated with that receiver. The caller's phone can then automatically provide the key code to the receiver's phone at 268. Such a means of automatically providing the key code may be a separate program that runs on the caller's phone, or it may run as an application on the phone's operating system. In the latter case the telephone network can be either a landline network or a mobile network or a combination of the two. Either one of the caller's and the receiver's phone may be on a landline and the other may be on a mobile network.

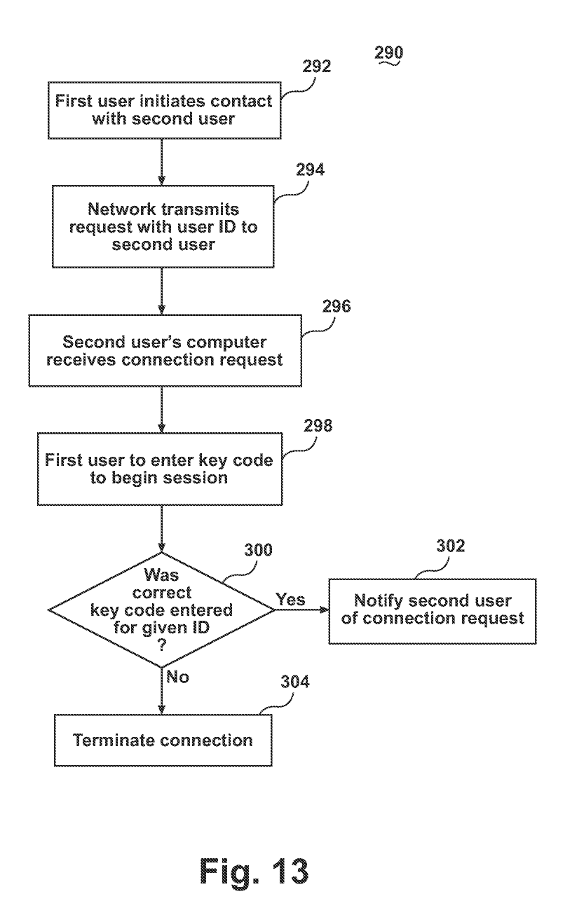

FIG. 13 is a flow diagram demonstrating a method 290 of sorting messages applied to Instant Messaging (IM). A user initiates contact with a second user at 292 and the network transmits the contact request with user identification to the second user at 294. The second user's electronic device 40 receives the connection request at 296 and the user has to enter a key code to begin the session at 298. It is determined if the user entered the correct key code at 300 and if the user has entered the correct key code, then the second user is notified of the connection request at 302. Otherwise the connection is terminated at 304.

Like the case of the method 260 associated with the telephone network and VoIP, the key code in the case of the IM method 290 may be entered manually by the initiating user or the process can be automated. For example, the directory on the initiator's IM software may contain a receiver's name and phone number as known in the art, but can also store a key code associated with that receiver. The initiator's IM software can then automatically provide the key code to the receiver's IM software at 268.

The sequence of steps depicted is for illustrative purposes only, and is not meant to limit the methods 60, 110, 140, 170, 200, 230, 260, and 290 in any way as it is understood that the steps may proceed in a different logical or sequential order and different, additional, overlapping, or intervening steps may be included without detracting from the invention.

The methods and systems disclosed herein provide a clear advantage in terms of reducing or eliminating unwanted messages by the use of key codes that are incorporated in, attached to, or logically associated with messages that are sent over a communications network 30. The use of key codes makes it unnecessary for messaging software 50 to make a judgment about whether the message is wanted by the receiver based upon the content, subject, attachments, or the sender of the message. Therefore, the methods disclosed herein reduce or eliminate the variability associated with whether a message is wanted. As the key code may just be one or two bytes in length, the addition and transmission of the key code or a message with a key code, adds an insignificant burden on the bandwidth of the communications network 30. The use of key codes also allow the messages in the recipient's inbox to be binned into various levels of trust, so that the recipient may take more precautions when accessing messages with lower levels of trust. Additional benefits are seen because the key code can be changed. This may be of great use if too many unwanted senders of messages have the current key code. Messages from unwanted senders can be eliminated by changing one's key code and not notifying unwanted senders of the change, thereby invalidating the key code known by the unwanted sender. Additionally, a method is disclosed for adding trusted senders based on known trusted senders using a referral system. The methods disclosed here can also be used in conjunction with other known means of filtering messages, including the use of anti-virus filtering software.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention which is defined in the appended claims.

What is claimed is:

1. A method of sorting a message received from a communications network, the method comprising:
ascertaining whether a key code is associated with the message by using messaging software in a controller, and if no key code is associated with the message, then assigning the message to a first category, and
checking whether the key code is valid wherein the controller compares it to a database in a memory, and if valid, then assigning the message to a second category, and if not valid, then assigning it to the first category.

2. The method of claim 1 wherein the message includes a sender identifier.

3. The method of claim 2 wherein the key code is one of a public key code and a private key code.

4. The method of claim 1 wherein the message assigned to the first category is not wanted by a receiver of the message.

5. The method of claim 1 wherein the message assigned to the second category is wanted by a receiver of the message.

6. The method of claim 1 wherein the message assigned to the first category is moved into a folder where messages may be reviewed prior to being deleted.

7. The method of claim 1 wherein the message assigned to the second category is moved to an inbox.

8. The method of claim 1 further comprising sending a reply to a sender of the message if no valid key code is associated with the message.

9. The method of claim 1 wherein associating the key code with the message is one of the key code being incorporated in, attached to, and logically associated with the message.

10. The method of claim 1 further comprising assigning a confidence level to the message assigned to the second category, the method comprising:
assigning a first level of confidence if the key code matches a valid public key code;
assigning a second level of confidence if the key code matches the valid public key code and a sender identifier is found the database;
assigning a third level of confidence if the key code matches a private key code associated with a sender identifier found in the database.

11. The method of claim 1 wherein determining the key code is performed by the messaging software parsing the message.

12. The method of claim 1 wherein the message is a telephone call, the sender identifier is unique information from a caller and the key code is one of digital and analog data.

13. The method of claim 10 further comprising the messaging software indicating the level of confidence of the message.

14. A system for sorting a message received from a communications network, comprising:
an electronic device having a controller, access to a memory, messaging software, and a connection to a communications network, wherein the memory has a database of valid key codes whereby when the electronic device is connected to a communications network and a message is received from the communications network, the controller can ascertain whether a key code is associated with the message using the communication software, and check the validity of the key code by comparing it to the database of valid key codes.

15. The system of claim 14 wherein the message is an email message and the key code is a data code that is one of incorporated in, attached to, and logically associated with the message.

16. The system of claim 14 wherein the message is a telephone call and the key code is one of digital and analog data.

17. The system of claim 14 wherein the database further contains a sender identifier related to a key code.

18. A method of preparing a message for sending over a communications network, the method comprising:
identifying a recipient for the message,
ascertaining whether an existing key code has been provided by the recipient by searching a database, and if not, then obtaining a new key code from the recipient, and
associating one of the existing key code and the new key code to the message for transmission over the communications network.

19. The method of claim 18 further comprising associating additional key codes corresponding to additional recipients to the message.

20. The method of claim 18 wherein the message is an email message and the key code is a data code that is one of incorporated in, attached to, and logically associated with the message.

21. The method of claim 18 wherein the message is a telephone call, the recipient is the number being called, and the key code is one of a digital and analog code.

22. The method of claim 18 further comprising associating a sender's key code to the electronic message.

23. The method of claim 22 further comprising the recipient receiving the message and storing the sender's key code in a database stored in a memory on a recipient's electronic device.
